(19) United States
(12) Patent Application Publication
(10) Pub. No.: US 2010/0034941 A1
(43) Pub. Date: Feb. 11, 2010

(54) CORN COB HOLDERS

(76) Inventor: Stephanie Vlahos, San Mateo, CA (US)

Correspondence Address: BUCHANAN, INGERSOLL & ROONEY PC, POST OFFICE BOX 1404, ALEXANDRIA, VA, 22313-1404, US

(21) Appl. No.: 12/188,972

(22) Filed: Aug. 8, 2008

(51) Int. Cl. A47G 19/00; A47G 19/30; A47G 21/00; A23L 1/01; A23L 1/212

(52) U.S. Cl. 426/421; 294/5

(57) ABSTRACT

A pair of corn cob holders comprising: a first corn holder having a housing with an elongated bore therein, the elongated bore having an end cap on one end thereof with an opening therein configured to receive one end of an ear of corn and an open end on an opposite end thereof, and a second corn holder having a housing with an elongated bore therein, the elongated bore having an end cap on one end thereof with an opening therein configured to receive an opposite end of an ear of corn and an open end on an opposite end thereof.

### TECHNICAL FIELD

The present invention relates to a pair of corn cob holders, and more particularly to a pair of silicone corn cob holders.

### BACKGROUND OF THE INVENTION

Corn on the cob, after cooking, is typically eaten either solely by hand, that is, by the user grasping each end of the corn cob, or more typically, by the aid and use of corn cob holders which are inserted into the one tip end and the other butt end of the corn cob in a secured fashion which enables the user to grasp such holders while eating the kernels off the corn cob.

There have been numerous corn cob holders suggested. In particular, those corn cob holders presented commercially available include a plastic handled corn cob holder with two protruding metal prongs which are inserted into each end of the corn cob. Another commercial model currently available includes a corn cob holder with wooden handles and featuring a small flat metal pointer for insertion into the corn cob. Other corn cob holders merely comprise a pointed stick which is inserted into the end of the corn cob. Corn cob holders should provide for the secure retention of the corn cob holder in each end of the corn cob so as to prevent rotation of the corn cob during eating and to provide a sufficient surface area of the handle so that the corn cob holder may be securely grasped.

It is desirable to provide for a corn cob holder and method in which the corn cob holder can be placed on the ear of corn before the corn is placed in a pot of water and during consumption, the holder will easily hold the corn cob in a firm, secure, non-rotatable position.

### SUMMARY OF THE INVENTION

In accordance with an exemplary embodiment, A pair of corn cob holders comprises: a first corn holder having a housing with an elongated bore therein, the elongated bore having an end cap on one end thereof with an opening therein configured to receive one end of an ear of corn and an open end on an opposite end thereof, and a second corn holder having a housing with an elongated bore therein, the elongated bore having an end cap on one end thereof with an opening therein configured to receive an opposite end of an ear of corn and an open end on an opposite end thereof.

In accordance with another exemplary embodiment, a corn holder comprises: a housing with an elongated bore therein, the elongated bore having an end cap on one end thereof with an opening therein configured to receive one end of an ear of corn and an open end on an opposite end thereof.

In accordance with a further exemplary embodiment, a method of preparing an ear of corn for consumption, the method comprises: placing a pair of corn holders on each end of the ear of corn; placing the ear of corn in a pot of water; removing the ear of corn from the pot of water; and consuming the ear of corn while grasping the pair of corn holders.

### BRIEF DESCRIPTION OF THE DRAWINGS

FIG. 1 is a perspective view of a pair of corn cob holders on an ear of corn in accordance with an exemplary embodiment.

FIG. 2 is another perspective view of the pair of corn cob holders of FIG. 1.

FIG. 3 is a side view of the pair of corn cob holders of FIG. 1.

FIG. 4 is another side view of the pair of corn cob holders of FIG. 1.

FIG. 5 is a top view of the pair of corn cob holders of FIG. 1.

FIG. 6 is a bottom view of the pair of corn cob holders of FIG. 1.

FIG. 7 is a top view of a pair of corn cob holders in accordance with another exemplary embodiment.

FIG. 8 is a side view of a pair of corn cob holders in accordance with another exemplary embodiment.

FIG. 9 is a flow chart showing a method of preparing an ear of corn for consumption.

FIG. 10 is a perspective view of a corn cob holder in accordance with another embodiment.

### DETAILED DESCRIPTION OF THE DRAWINGS

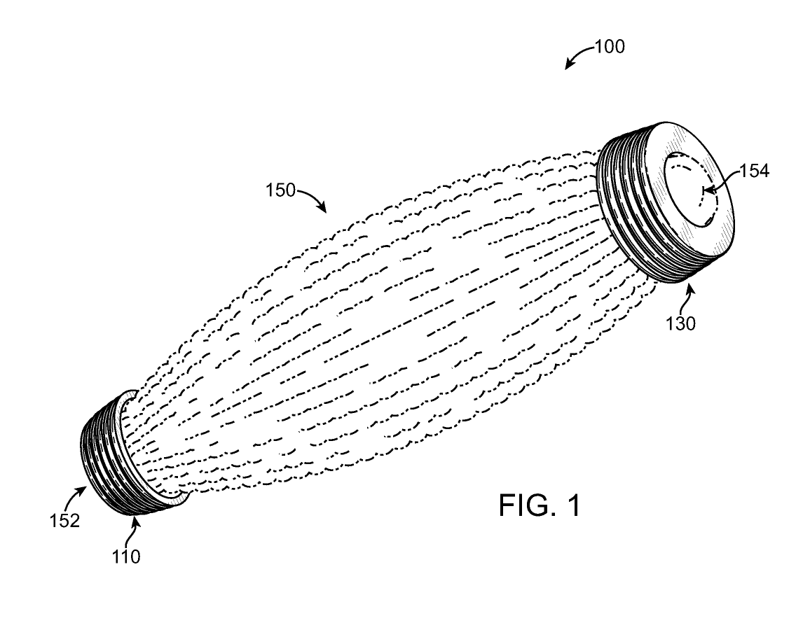

FIG. 1 is a perspective view of a pair of corn cob holders 100 on an ear of corn 150 in accordance with an exemplary embodiment. As shown in FIG. 1, the pair of corn cob holders 100 comprises a first corn holder 110 and a second corn holder 130, which are positioned on one end 152 and an opposite end 154 of the ear of corn 150, respectively.

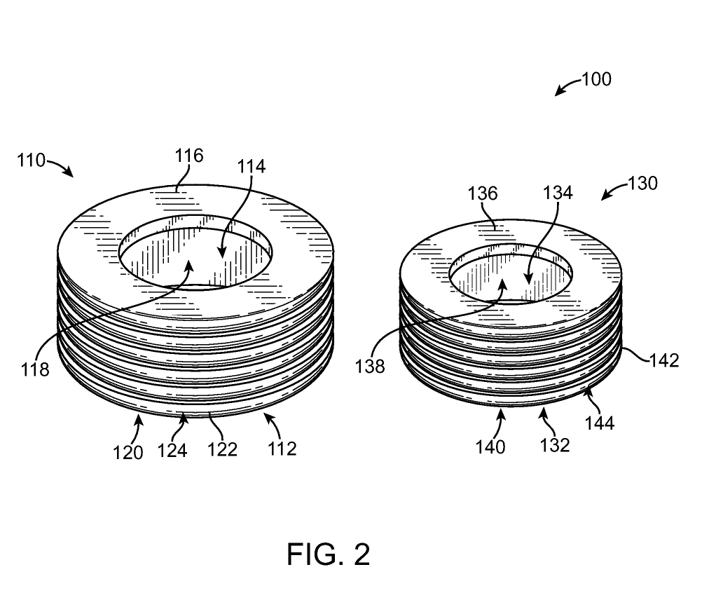

FIG. 2 is another perspective view of the corn cob holders 100 of FIG. 1. As shown in FIG. 2, the corn holders 110, 130 each include a housing 112, 132, with an elongated bore 114, 134 therein, the elongated bore 114, 134 having an end cap 116, 136 on one end thereof with an opening 118, 138 therein configured to receive an ear of corn 140 and an open end 120, 140 on an opposite end thereof. Each of the corn holders 110, 130 includes an outer surface 124, 144, which can include a pattern or design. For example, in accordance with an exemplary embodiment, the outer surfaces 124, 144 include a plurality of grooves or channels 122, 142.

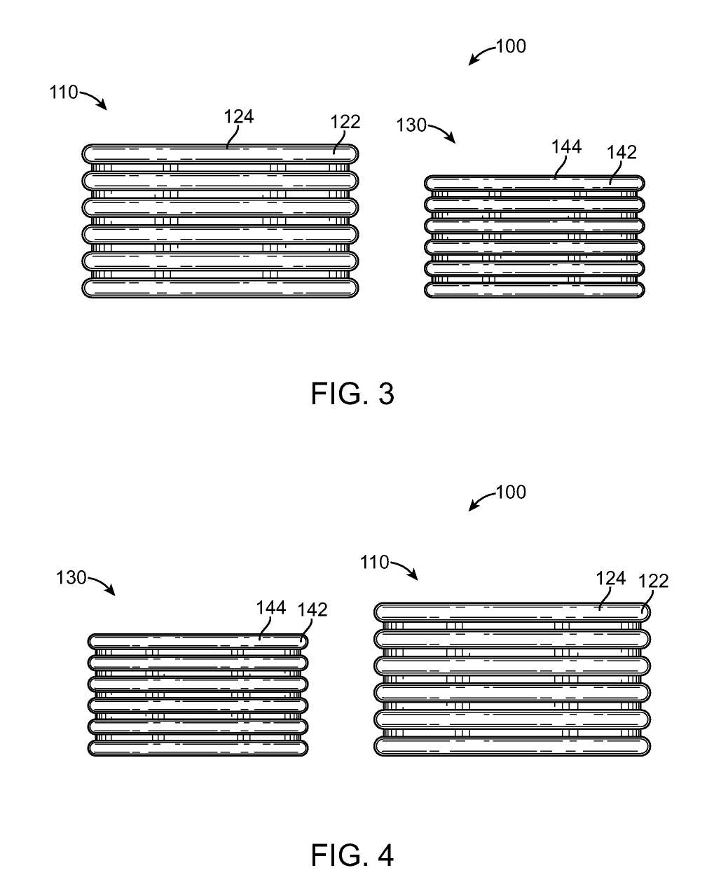

In accordance with an exemplary embodiment as shown in FIGS. 3 and 4, the corn cob holders 110, 130 have a pattern or design on the outer surface 124, 144 of the housing 112, 132 in the form of a plurality of grooves or channels 122, 142 with a generally semi-circular cross-section. In accordance with an alternative exemplary embodiment, the plurality of grooves or channels 122, 142 have a generally rectangular cross-section (FIG. 8). However, it can be appreciated that the plurality of grooves or channels 122, 142 can have any suitable configuration and/or cross-sectional shape. In accordance with an exemplary embodiment, and as shown in FIGS. 3 and 4, the first and second holders 110, 130 are different sizes to accommodate the smaller and the larger ends 152, 154 of the ear of corn 150.

In accordance with an exemplary embodiment, the pair of corn holders 110, 130 is made of a suitable rubber-like material, which is frequently used in cookware, medical applications, sealants, lubricants, which is preferably heat-resistant. In accordance with another exemplary embodiment, the pair of corn holders 100 is made of a polymeric material such as silicone.

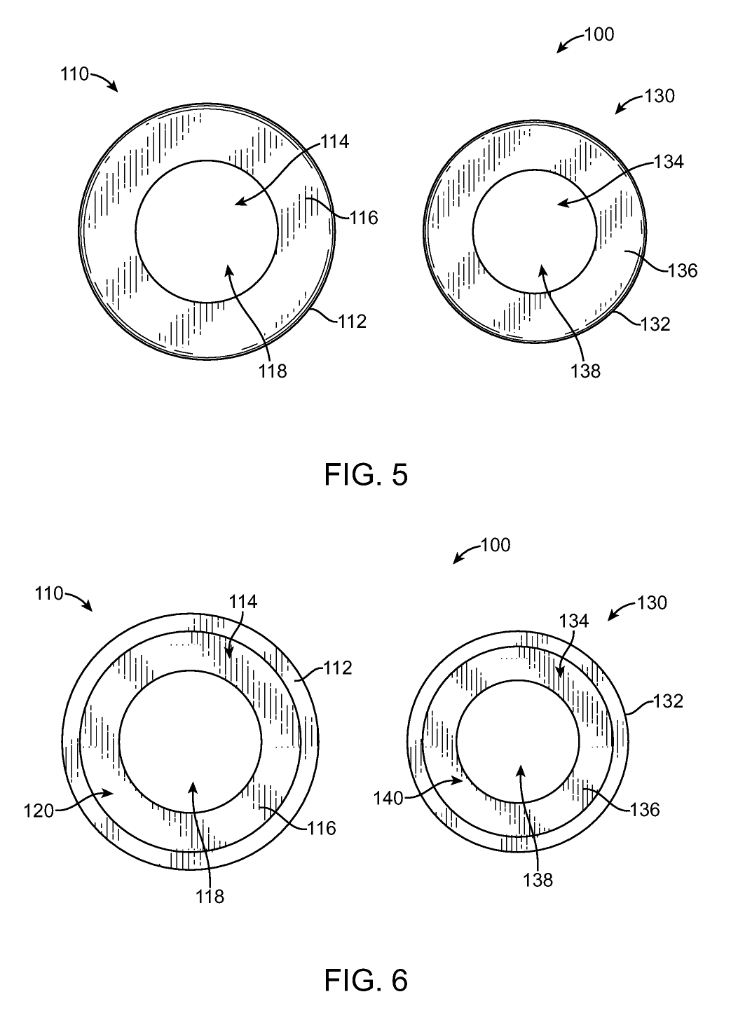

FIGS. 5 and 6 are a top view and a bottom view, respectively, of the pair of corn cob holders 100. As shown in FIGS. 5 and 6, the corn holders 110, 130 each include a housing 112, 132, with an elongated bore 114, 134 therein, the elongated bore 114, 134 having an end cap 116, 136 on one end thereof with an opening 118, 138 therein configured to receive an ear of corn 150 and an open end 120, 140 on an opposite end thereof.

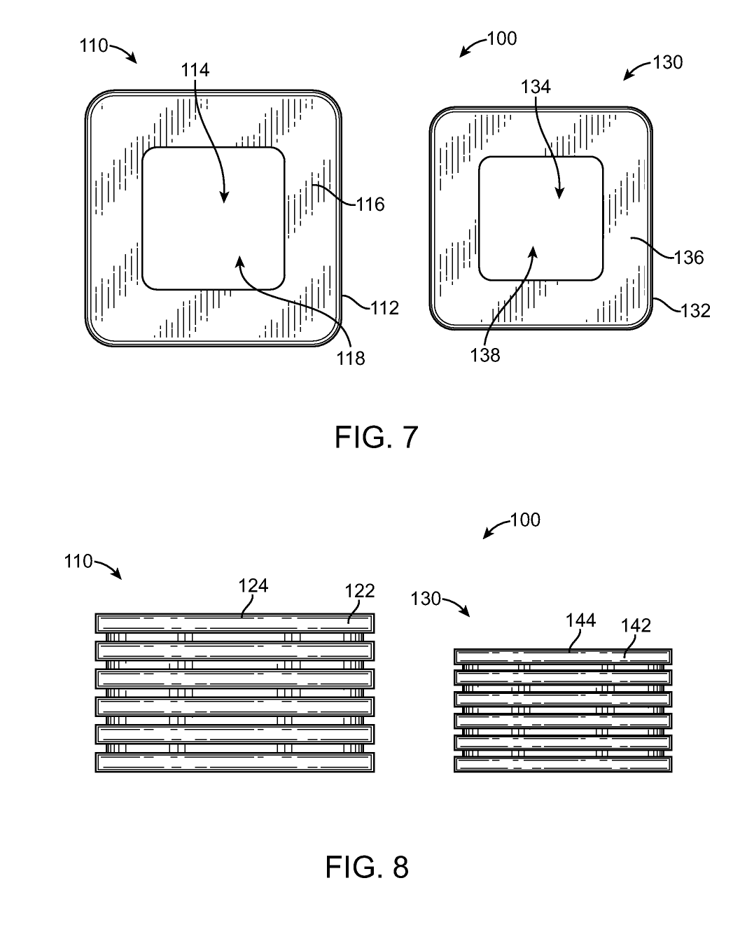

In accordance with another exemplary embodiment, as shown in FIG. 7, the corn holders 110, 130 can alternatively include a housing 112, 132 having a non-circular perimeter, with an elongated bore 114, 134 therein, the elongated bore 114, 134 having an end cap 116, 136 on one end thereof with an opening 118, 138 therein configured to receive an ear of corn 150 and an open end 120, 140 on an opposite end thereof. It can be appreciated that the housing 112, 132 can have various shapes including circular or round, rectangular or square, and other shapes and sizes.

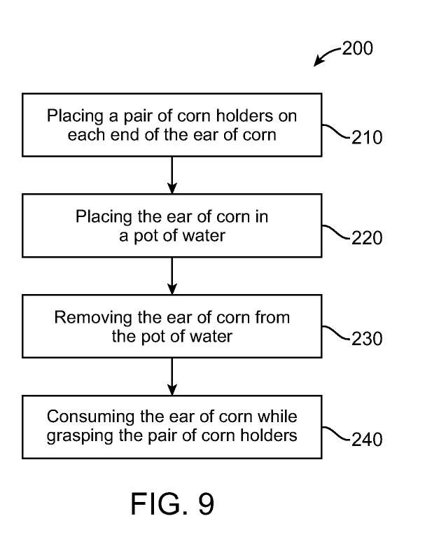

In accordance with an exemplary embodiment, a method of preparing 200 an ear of corn for consumption is shown in FIG. 9. The steps include step 210, placing a pair of corn holders on each end of the ear of corn. In step 220, placing the ear of corn in a pot of water, and step 230, removing the ear of corn from the pot of water. In step 240, consuming the ear of corn while grasping the pair of corn holders. In accordance with an exemplary embodiment, the pot of water is a pot of cold water and the pot of cold water is brought to a boil. In accordance with an alternative embodiment, the pot of water is a pot of boiling water.

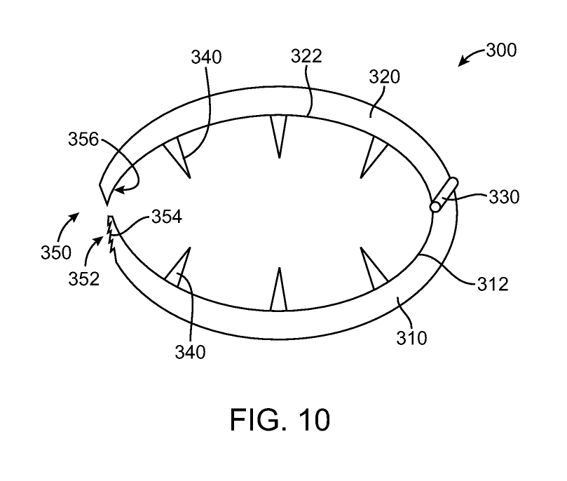

FIG. 10 is a perspective view of a corn cob holder 300 in accordance with another embodiment. As shown in FIG. 10, the corn cob holder 300 includes a pair of lever members 310, 320 having at least one hinge (i.e., a hinge) 330 on an outer edge thereof. As shown in FIG. 10, the at least one hinge 330 allows for the pair of lever members 310, 320 to vary in sized to accommodate ears of corn of various sizes and shapes. On an opposite outer edge of the corn cob holder (i.e., open end 350), the pair of lever members 310, 320 can have a series of striations or other markings 354 so that an inner portion 352 of one of the lever members 310, 320 overlaps an outer portion 356 of the other lever member 310, 320. An inner surface 312, 322 of the each of the lever members 310, 320 includes a plurality of teeth or projections 340, which are adapted to grasp the ends of the ear of corn. The user preferably places a corn cob holder 300 on each end of the ear of corn and uses the pair of lever members 310, 320 to grasp or hold the ear of corn during consumption.

It can be appreciated that in accordance with an alternative embodiment, the pair of the lever members 310, 320 can be pivotally connected to one another via the at least one hinge 330. In accordance with an embodiment, the at least one hinge 330 preferably includes a pin and a spring-like mechanism for biasing the plurality of teeth or projections 340 of the lever members 310, 320 to move towards each other. In accordance with an exemplary embodiment, the at least one hinge 330 is preferably located at center portion of the pair of lever members 310, 320, which results in the pair of lever members 310, 320 moving towards one another to grasp the ear or corn. By placing the at least one hinge 330 at the center portion of the pair of lever members 310, 320, the corn cob holder 300 opens and closes around the ear of corn.

It will be understood that the foregoing description is of the preferred embodiments, and is, therefore, merely representative of the article and methods of manufacturing the same. It can be appreciated that variations and modifications of the different embodiments in light of the above teachings will be readily apparent to those skilled in the art. Accordingly, the exemplary embodiments, as well as alternative embodiments, may be made without departing from the spirit and scope of the articles and methods as set forth in the attached claims.

What is claimed is:

1. A pair of corn cob holders comprising:
a first corn holder having a housing with an elongated bore therein, the elongated bore having an end cap on one end thereof with an opening therein configured to receive one end of an ear of corn and an open end on an opposite end thereof, and
a second corn holder having a housing with an elongated bore therein, the elongated bore having an end cap on one end thereof with an opening therein configured to receive an opposite end of an ear of corn and an open end on an opposite end thereof.

2. The holders of claim 1, further comprising a plurality of grooves on an outer surface of the bore.

3. The holders of claim 2, wherein the plurality of grooves have a generally semi-circular cross-section.

4. The holders of claim 2, wherein the plurality of grooves have a generally rectangular cross-section.

5. The holders of claim 1, wherein the pair of corn holders is made of a rubber-like material.

6. The holders of claim 1, wherein the pair of corn holders is made of silicone.

7. The holders of claim 1, wherein the first and second holders are different sizes to accommodate a small and a large end of the ear of corn.

8. A corn holder comprising:
a housing with an elongated bore therein, the elongated bore having an end cap on one end thereof with an opening therein configured to receive one end of an ear of corn and an open end on an opposite end thereof.

9. The holder of claim 8, further comprising a plurality of grooves on an outer surface of the bore.

10. The holder of claim 9, wherein the plurality of grooves have a generally semi-circular cross-section.

11. The holder of claim 9, wherein the plurality of grooves have a generally rectangular cross-section.

12. The holder of claim 8, wherein the corn holder is made of a rubber-like material.

13. The holder of claim 8, wherein the corn holder is made of silicone.

14. A method of preparing an ear of corn for consumption, the method comprising:
placing a pair of corn holders on each end of the ear of corn;
placing the ear of corn in a pot of water;
removing the ear of corn from the pot of water; and
consuming the ear of corn while grasping the pair of corn holders.

15. The method of claim 14, wherein the pot of water is a pot of cold water and the pot of cold water is brought to a boil.

16. The method of claim 14, wherein the pot of water is a pot of boiling water.
